(19) United States
(12) Patent Application Publication
(10) Pub. No.: US 2009/0250940 A1
(43) Pub. Date: Oct. 8, 2009

(54) Self sufficient electro/magnet engine unit

(76) Inventor: Joseph Francis Urban, Biloxi, MS (US)

Correspondence Address: Joseph F. Urban, 2550 Spring Ridge Dr., Biloxi, MI, 39531, US

(21) Appl. No.: 12/074,533

(22) Filed: Apr. 3, 2008

(51) Int. Cl. H02K 7/18

(52) U.S. Cl. 290/1 A; 310/15

(57) ABSTRACT

Apparatus to build a self sufficient electromagnet engine unit.

Mechanically creating:

Using a number of electromagnet solenoids sets, pistons with connecting rods to the crank shaft.

Batteries with connectors to the solenoids to supply power to start up the unit.

Distributor for timing and synchronizing the current flow to the unit.

Alternator to supply electricity to the whole unit.

It uses no fuels of any kind. It runs on electricity, create its own power and recharges its own battery.

It creates no pollution, economically feasible, and it can be used for many different kinds of applications, commercial as well as industrial.

### BACKGROUND AND SUMMERY OF THE INVENTION

The invention is based on a mechanically creating a self sufficient electro magnet engine unit. Economically feasible, pollution free, and create clean energy. Using no fuel of any kinds. Runs on electric power, generate its own electricity, and the starting battery needs no periodical re-charging. Once it is start, it will runs for a long time,

It can be used for many different types of application, commercial as well as industrial.

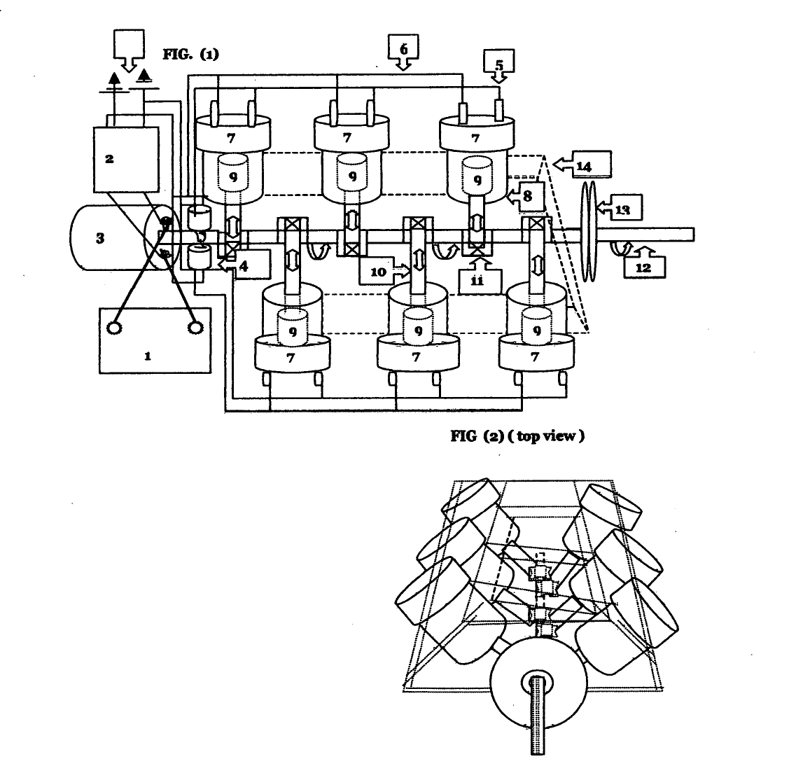

### BRIEF DESCRIPTION OF THE DRAWING FIG. 1.

1, Using a 12, 24, 36, 48 or any size-volt battery to start up the engine, (depends of the design of the engine).

2, A variable control box to control the electric flow to the solenoids in the cylinder heads and that will control the RPM of the electro magnet engine.

3, Alternator is connected to the crank shaft, it could be via belt or a gear system, depends on the design of the engine, It will supply the electricity to the whole unit.

4, Electrical or mechanical timing distributor to the solenoids.

5, Ground wires and connectors to the coils assembly.

6, Hot wires and connectors to the coils assembly.

7, Connector assembly to the solenoids.

8, Cylinders heads and solenoids assembly.

9, Pistons.

10, Connecting rods from the pistons to the crank shaft.

11, Bearing assembly for the connecting rods to the crank shaft.

12, Crank shaft.

13, Flywheel. ( it could be designed as a cooling fan also)

14, Engine and frame assembly.

15, FIG. 2, Top view of the electro magnet engine,

### DISCLOSURE AND OPERATION OF THE INVENTION

As I have stated earlier, the self sufficient electro magnet engine unit operate on the same idea as the internal combustion engine does. Just like the internal combustion engine needs a perfect distribution timing of the electric sparks to create a perfect synchronized explosion, and with that a controlled RPM.

The self sufficient electro magnet engine unit also operate on a perfect synchronized timing of the current flown to the different solenoid in a different cylinder head, and with that creating a controlled RPM.

(1) the current flows from the battery, (2) through the variable control unit which plays a major role to control the electricity to the distributor, and with that also controls the speed of the engine, (RPM) (3) the alternator with a voltage regulator on it, delivers the right amount of electricity to the distributor, (4) timing and synchronization of the distributors which controls the RPM of the engine, (5) ground wires from the distributor to the coils assembly, (6) hot wires from the distributor to the coils assembly which delivers the electricity to the solenoids, (7) the connector assembly to the solenoids, (8) cylinders heads and solenoids assembly, the power of an engine is depends upon the winding of the coils, (9) the size of the cylinders also play a major roles of the output of the engine torque, (10) the size and firmness of the connecting rods from the piston to the crank shaft, also depends on the power delivery to the crank shaft, (11) the bearing assembly from the connecting rods to the crank shaft, is very important for its smoothness as well as its perfect fittings, just like in the internal combustion engine bearings rotates in an oil bath, (12) the crank shaft also depends on its size and toughness to deliver the right amount of torque to the transmission, (13) the flywheel also play a major role of the operation to the electro magnet engine unit, it help create balancing as well as increase power, (14) frame assembly of the engine is made up of various parts and sizes just like the internal combustion engine have, this will create less hardship to the technician to work on repairs, (15) FIG. 2, is a top view of the electro magnet engine unit, looking at the side view, one would think this is a regular internal combustion engine, shape like it and look like it.

What is claimed is:

1. Be it known that I Joseph Francis Urban live in the City of Biloxi County of Harrison State of Mississippi.
I invented a new and useful motor, I called it a self sufficient electro magnet engine unit. It uses no fuels of any kind, runs on electricity, create its own power and it need no periodical recharging. As it runs, re-charges the starting battery and supply all the electricity to the whole unit.
The principle objection of this invention is to provide an economical gain, pollution free clean air for the present as well as for the future.
Operation of the self sufficient electro magnet engine unit working on the same idea as the internal combustion engine works, with only difference; the internal combustion engine pistons working on an explosion in the cylinder head (chamber) and creating a pushing motion to the piston and the connecting rod which is attached to the crank shaft, with this motion creating a reciprocating and a rotational motion to the crank shaft.
The electro magnet engine operate when the electric current flows through the coils, it will create an artificial magnetism in the cylinder head and it become magnetized, it attracts the piston and the connecting rod with a pulling motion which is attached to the crank shaft. With the help of the electric current distributor (just like in the internal combustion engine) this controls the electricity to the solenoids, in a different cylinder head, at a different timing.
When the electricity ceases to flow to the coil, the core will loose its magnetism, that will create a reciprocating motion, and that will set the crank shaft into rotational motion.
The power and creation of the engine is depends on the design of the coil windings, (solenoids) the size of the piston and the cylinder heads.
Just like the internal combustion engines.
Described in considerable details with respect to preferred embodiment there of,
It will be apparent that the invention is capable of numerous modification and
Variation apparent to those skilled in the art without departing from the spirit and scope of the invention.
